(19) United States
(12) Patent Application Publication
(10) Pub. No.: US 2010/0240354 A1
(43) Pub. Date: Sep. 23, 2010

(54) COMMUNICATION METHOD AND DEVICE EMPLOYING THE SAME

(75) Inventors: Lung Dai, Tu-Cheng (TW); Bang-Sheng Zuo, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/608,969

(22) Filed: Oct. 29, 2009

(30) Foreign Application Priority Data
Mar. 18, 2009 (CN) 200910300937.X

(51) Int. Cl. H04W 76/02

(52) U.S. Cl. 455/422.1

(57) ABSTRACT

A communication method whereby a connection between a first communication device and a second communication device is established. Determining whether the connection is disconnected by the second communication device. If the connection is disconnected by the second communication device, related features are invoked by the first communication device to alert a user of the first communication device that the connection has been disconnected by the second communication device.

### BACKGROUND

1. Technical Field

The present disclosure relates to communication technologies, and particularly to a communication method and device.

2. Description of Related Art

When a connection between a first cell phone and a second cell phone is suddenly disconnected due to insufficient funds/credit in one of the account of the cell phones, it may not be known instantly.

Therefore, improved communication methods and communication devices employing the same are desired.

### BRIEF DESCRIPTION OF THE DRAWINGS

FIG. 1 is a flowchart of a communication method in accordance with an exemplary embodiment.

FIG. 2 is a block diagram of a communication system in accordance with an exemplary embodiment.

### DETAILED DESCRIPTION

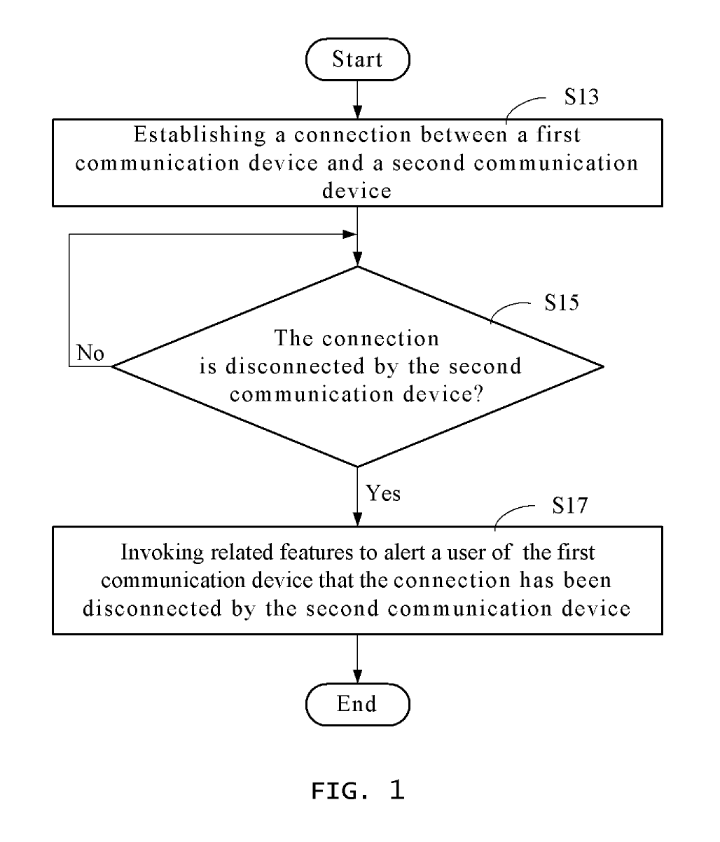

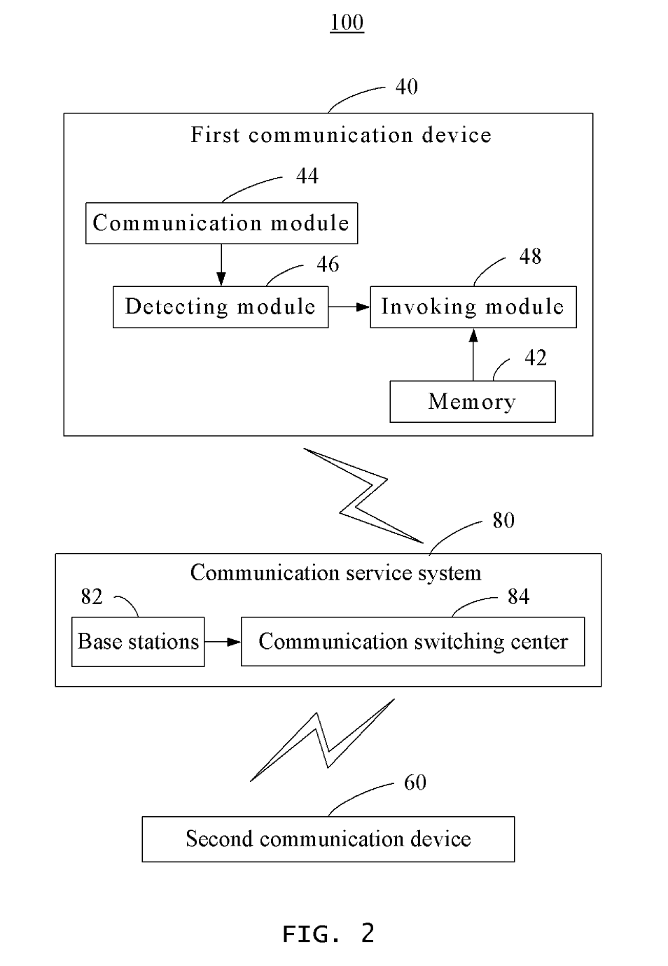

Referring to FIG. 1, a communication method may be implemented by a first communication device 40 (referring to FIG. 2) in the form of program codes or instructions. The first communication device 40 may be a cell phone or a personal digital assistant (PDA) with communication functions or others. When receiving an incoming call from a second communication device 60 via a communication service system 80, the first communication device 40 executes the program codes to implement the communication method. The communication method includes following steps.

In step S13, establishing a connection between the first communication device 40 and the second communication device 60. Voice and data can be transmitted between the first communication device 40 and the second communication device 60 over the connection.

In step S15, detecting whether the connection is disconnected by the second communication device 60. If the connection is disconnected by the second communication device 60, step S17 is implemented. If the connection is not disconnected by the second communication device 60, the procedure returns to step S15.

In the embodiment, detecting whether the first communication device 40 receives a clear signal transmitted by the communication service system 80 to determine whether the connection is disconnected. If the first communication device 40 receives the clear signal transmitted by the communication service system 80, the connection 60 is disconnected.

In step S17, invoking related features to alert a user of the first communication device 40 that the connection has been disconnected via the first communication device 40. In one embodiment, the related features may be outputting audible sounds. The audible sounds may be ring tones stored in the first communication device 40 beforehand or default ring tones obtained from a service provider operating the communication service system 80.

In other embodiments, at least one step of the communication method may be implemented by the communication service system 80 instead of the first communication device 40. For example, the related features invoked in step S17 may be implemented by the communication service system 80. In this case, the audible sounds may be ring tones stored in the communication service system 80.

Referring to FIG. 2, a communication system 100 includes a first communication device 40, a second communication device 60, and a communication service system 80. The communication system 100 can alert that a connection between the first communication device 40 and the second communication device 60 has been disconnected by the second communication device 60. The above-describing “alert” action can be implemented by the first communication device 40, the second communication device 60, or the communication device 80. In the embodiment, the above-describing “alert” action is implemented by the first communication device 40 for illustration.

The first communication device 40 and the second communication device 60 may be cell phones or a personal digital assistants (PDAs) with communication functions or others. The communication service system 80 is used for communicating between the first communication device 40 and the second communication device 60.

The first communication device 40 includes a memory 42, a communication module 44, a detecting module 46, and an invoking module 48.

The communication module 44 is used for communicating with the second communication device 60 via the communication service system 80. The communication service system 80 includes base stations 82 and a communication switching center 84. The communication switching center 84 is used for controlling the base stations 82 to establish and disconnect communication channels between the first communication device 40 and the second communication device 60.

The memory 42 is used for storing features related to a communication state between the first communication device 40 and the second communication device 60. The related features may be outputting audible sounds.

The detecting module 46 is used for detecting whether the connection is disconnected by the second communication device 60, and generating a detecting signal when the connection is disconnected by the second communication device 60. In the embodiment, when the second communication device 60 disconnects the connection the communication switching center 84 transmits a clear signal to the communication module 44 via the base stations 82. The detecting module 46 detects if the communication module 44 receives the clear signal and generates the detecting signal when the communication module 44 receives the clear signal.

The invoking module 48 is used for invoking the features from the memory 42 in response to the detecting signal, to alert a user of the first communication device 40 that the connection has been disconnected by the second communication device 60.

In other embodiments, at least one of the memory 42, the detecting module 46, and the invoking module 48 may be transferred from the first communication device 40 to the communication service system 80. That is, the communication service system 80 may include at least one of the memory 42, the detecting module 46, and the invoking module 48.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A communication method implemented by a first communication device for facilitating communication between the first communication device and a second communication device, the communication method comprising:
establishing a connection between the first communication device and the second communication device;
detecting whether the connection is disconnected by the second communication device; and
if the connection is disconnected by the second communication device, invoking related features by the first communication device to alert a user of the first communication device that the connection has been disconnected by the second communication device.

2. The communication method according to claim 1, further comprising:
if the connection is not disconnected by the second communication device, further detecting whether the connection is disconnected by the second communication device.

3. The communication method according to claim 1, wherein the related features comprise outputting audible sounds.

4. The communication method according to claim 3, wherein the audible sounds are ring tones stored in the first communication device.

5. The communication method according to claim 3, wherein the audible sounds are default ring tones obtained from a service provider operating a communication service system, the communication service system communicates between the first communication device and the second communication device.

6. The communication method according to claim 1, wherein the first communication device communicates with the second communication device via a communication service system, detecting whether the first communication device receive a clear signal transmitted by the communication service system to determine whether the connection between is disconnected, if the first communication device receives the clear signal transmitted by the communication service system, the connection is disconnected.

7. A communication method using a communication service system communicating between a first communication device and a second communication device, the communication method comprising:
establishing a connection between the first communication device and the second communication device;
detecting whether the connection is disconnected by the second communication device; and
if the connection is disconnected by the second communication device, invoking related features by the communication service system to alert a user of the first communication device that the connection has been disconnected by the second communication device.

8. The communication method according to claim 7, further comprising:
if the connection is not disconnected by the second communication device, further detecting whether the connection is disconnected by the second communication device.

9. The communication method according to claim 7, wherein the related features comprise outputting audible sounds.

10. The communication method according to claim 9, wherein the audible sounds are ring stones stored in the communication service system.

11. A communication device, comprising:
a communication module configured to communicate with another communication device;
a memory storing features related to a communication state between the communication device and the another communication device;
a detecting module detecting whether a connection between the communication device and the another communication device is disconnected by the another communication device and generating a detecting signal when the connection is disconnected by the another communication device; and
an invoking module for invoking features from the memory in response to the detecting signal, to alert a user of the communication device that the connection has been disconnected by the another communication device.

12. The communication device according to claim 11, wherein the related features comprise outputting audible sounds.

13. The communication device according to claim 11, wherein the communication device communicates with the another communication device via a communication service system, the detecting module detects whether the communication module receives a clear signal transmitted by the communication service system to determine whether the connection is disconnected.

14. The communication device according to claim 13, wherein the communication device comprises base stations and a communication switching center, the communication switching center is used for controlling the base stations to establish and disconnect communication channels between the communication device and the another communication device, and when the another communication device disconnects the connection, the communication switching center transmits the clear signal to the communication module via the base stations, the detecting module detects if the communication module receives the clear signal and generates the detecting signal when the communication module receives the clear signal.
